(19) United States
(12) Patent Application Publication
(10) Pub. No.: US 2018/0026263 A1
(43) Pub. Date: Jan. 25, 2018

(54) BATTERY WITH A SPECIFIC LIQUID CATHODE WHICH MAY OPERATE AT HIGH TEMPERATURES

(71) Applicant: COMMISSARIAT A L'ENERGIE ATOMIQUE ET AUX ENERGIES ALTERNATIVES, Paris (FR)

(72) Inventors: Eric Mayousse, GRENOBLE (FR); Lionel Blanc, GRENOBLE (FR); Benoit Chavillon, GRENOBLE (FR); Philippe Chenebault, POITIERS (FR)

(21) Appl. No.: 15/548,162

(22) PCT Filed: Feb. 10, 2016
(86) PCT No.: PCT/EP2016/052851

§ 371 Date: Aug. 2, 2017

(30) Foreign Application Priority Data
Feb. 10, 2015 (FR) 1551061

(51) Int. Cl. H01M 4/36; H01M 10/054; H01M 4/66; H01M 10/0567; H01M 10/0569; H01M 10/0568; H01M 10/058; H01M 4/38; H01M 4/70

(52) U.S. Cl. CPC H01M 4/368; H01M 4/381; H01M 10/054; H01M 4/663; H01M 4/70; H01M 10/0569; H01M 10/0568; H01M 10/058; H01M 10/0567; H01M 2004/021

(57) ABSTRACT

The invention relates to a liquid cathode cell including: a calcium anode; an electrolyte containing a sulphurous or phosphorous oxidising solvent and at least one salt; and a cathode containing, as an active material, a compound that is identical to the aforementioned oxidising solvent. The invention is characterised in that the salt is a strontium salt which is present in a concentration of from 1.15 mol·L⁻¹ to 3 mol·L⁻¹.

### TECHNICAL FIELD

The present invention relates to a battery with a specific liquid cathode and, more specifically to a battery with a liquid cathode and with a calcium anode which may operate in a wide range of temperatures, and notably in extended temperature ranges, for example ranging from −40° C. to +300° C. and, more specifically from −40° C. to +250° C.

Also, the present invention may find application in all fields requiring the production of electric energy, in contexts where the deviations in temperatures may be high but also in contexts where the temperature is particularly high, such as this is the case in the field of drilling or of the monitoring of producing wells or further in geothermy, the battery being, more specifically, used in this field for powering measurement systems.

### STATE OF THE PRIOR ART

As mentioned above, the batteries of the invention are based on the technology of batteries with a liquid cathode, which has the particularity that the active compounds used at the cathode also fulfills the role of a solvent of the electrolyte, one of the leading models of this type of battery is the lithium-thionyl chloride battery.

Thus, such a system 1 conventionally consists, as illustrated in FIG. 1 enclosed as an annex, of the following elements:
a negative electrode (or anode) 3 in metal lithium, wherein occurs the oxidation of lithium according to the following reaction:

Li→Li⁺+e⁻
a positive electrode (or cathode) 5 generally comprising a carbonaceous matrix and, as an active material, thionyl chloride, which is reduced according to the following reaction:

2 SOCl₂+4e⁻→S+SO₂+4Cl⁻
an electrolyte 7 positioned between said negative electrode and said positive electrode, which electrolyte includes, as a solvent, thionyl chloride, salts and optionally one or several additives,

the negative electrode and the positive electrode being connected to an outer circuit 9, which receives the electric current produced via the aforementioned electrodes.

By combining the electrochemical reaction at the positive electrode and the electrochemical reaction at the negative electrode, the overall reaction (a so-called discharge reaction) may be schematized by the following equation:

4 Li+2SOCl₂→S+SO₂ (gas)+4LiCl (precipitate)

the products of the reaction thus being sulfur, partly soluble in the electrolyte, SO₂ gas, which solubilizes in the electrolyte and a lithium chloride LiCl salt which precipitates in the constitutive carbonaceous matrix of the positive electrode.

The electrolyte includes, in addition to thionyl chloride, lithium salts, such as LiAlCl₄ or LiGaCl₄ for promoting ion conduction of the electrolyte as well as optionally additives for controlling the formation of the passivation layer of the lithium and reducing the self-discharge of the battery.

The constitutive carbonaceous matrix of the positive electrode is used, as mentioned above, at least partly, as a matrix for recovering reaction products and generally consists of a selected carbonaceous material, for example from among acetylene black, carbon fibers, which carbonaceous material is reinforced by a binder, preferably an inert binder, like polytetrafluoroethylene, which allows mechanical strength of the electrode.

From the point of view of their electrochemical characteristics, the batteries Li/SOCl₂ have the following advantages:
a thermodynamic voltage of 3.64 V per cell based on the variation of free enthalpy due to the overall aforementioned discharge reaction;
a high theoretical mass energy of 1,470 Wh/kg (of the order of 5273 kJ/kg);
a very low self-discharge phenomenon (evaluated at 1% of capacity loss per year at a temperature of 20° C.);
an operating temperature ranging from −60° C. (limitation imposed by the electrolyte) to 180° C. (limitation imposed by the lithium metal); and
a low internal pressure, because the gas reaction products such as SO₂ are soluble partly in the electrolyte.

However, this system also has a certain number of drawbacks, notably because of the reactivity of lithium metal with the humidity of the air or of the water, for forming hydrogen, lithine LiOH with production of heat. Furthermore, a passivation layer is formed at the surface of the lithium (this layer comprising LiCl), which may cause a voltage drop during a current inrush.

Finally, as suggested above, the use of this system is theoretically limited to a temperature of 180° C., melting point of the lithium beyond which short-circuits occur generating thermal runoff and an overpressure of the battery, which may lead to its destruction.

Also, at temperatures ranging beyond 180° C., the use of such batteries is no longer possible because of the melting of lithium. Moreover, the use of batteries with lithium anodes poses safety problems occurring during their production, their transport, their use or even their recycling.

In order to overcome these drawbacks, it was proposed to use, as a constitutive material of the negative electrode, a material based on a lithium alloy with a second metal which has a melting point greater than that of lithium metal alone, an alloy of this type being an alloy of lithium and of magnesium, as notably described in U.S. Pat. No. 5,705,293, and more specifically, alloys including a 30% proportion of magnesium, which gives the possibility of accessing temperatures of use from 200-220° C. Indeed, the introduction of magnesium in this proportion induces a displacement towards higher values of melting temperature, as confirmed by the phase diagram Li/Mg.

However, taking into account the strong internal resistance of these batteries including such an alloy at the negative electrode, it is necessary to condition them before use, these conditioning operations may prove to be a constraint for the user. On the other hand, in the case of exceeding the melting temperature of the anode, these batteries may also have safety problems.

Alternatively, more secure batteries were also proposed than lithium batteries, these batteries operating with an anode, no longer in lithium, but in calcium and a cathode based on thionyl chloride, this type of battery being called Ca/Thionyl chloride battery.

In particular, Peled et al. (in J. Electrochem. Soc. Vol. 128, no. 9, 1936-1938 and J. Electrochem. Soc. Vol. 131, no. 10, 2314-2315) describe Ca/Thionyl chloride batteries having a so-called spiral structure, for which the electrolyte includes a salt of the Ca(AlCl₄)₂ type at different concentrations. This battery definition gave the possibility of discharging batteries at room temperature very safely. In these studies, if the results seem promising, there however subsists a need for solutions giving the possibility of obtaining similar performances to batteries based on lithium in terms of corrosion and conductivity.

In order to improve the use of calcium for entering the constitution of the anode, Walker et al. (J. Electrochem. Soc, Vol. 135, no. 10, p. 2471-2472) have used an electrolyte always including a salt of the Ca(AlCl₄)₂ type, with a solvent of the sulfuryl chloride type, to which was added a solution of SO₂, which gave the possibility of reducing the corrosion phenomenon and of increasing the operating voltage of the system.

Alternatively, for making up the anode calcium alloys, such as calcium/lithium alloys (with 2% of lithium) and calcium/antimony alloys (with 10% of antimony) were also proposed for use, as discussed in J. Electrochem. Soc. (139), 3129-3135, and with, for an electrolyte of thionyl chloride containing, as a salt, Ca(AlCl₄)₂ or Li(AlCl₄), without however demonstrating with these batteries, performances at high temperatures.

Finally, an electrolyte comprising as a salt Ca(AlCl₄)₂ to which is added SO₂ and as a cathode, a carbonaceous electrode to which was added for example TiO₄ were also tested with batteries with calcium. These additives above all gave the possibility of demonstrating an increase in the conductivity of the electrolyte and therefore of attaining larger discharge currents, and this at room temperature.

Considering the drawbacks mentioned above, the authors of the present invention therefore set the goal of setting into place a new type of calcium battery, this novel type allowing a use at temperatures ranging from beyond 200° C. in a secured way.

### DISCUSSION OF THE INVENTION

The authors of the present invention have discovered, surprisingly, that by using in the electrolyte, a specific salt at a specific concentration, it is possible to obtain efficient performances at high temperatures and exceeding 200° C. Also, the invention relates to a battery with a liquid cathode comprising:
a calcium anode;
an electrolyte comprising a sulfur-containing and/or phosphorus-containing oxidizing solvent and at least one salt;
a cathode comprising as an active material, a compound identical to the aforementioned oxidizing solvent;

characterized in that the salt is a strontium salt present at a concentration ranging from 1.15 mol·L⁻¹ to 3 mol·L⁻¹.

Before entering in more details of the discussion of the invention, we specify the following definitions.

By cathode, is conventionally meant in the foregoing and in the following, the electrode which is the center of a reduction reaction, in this case here, the reduction of the liquid cathode, when the battery outputs current, i.e. when it is in a discharge process. The cathode may also be described as a positive electrode.

By anode, is conventionally meant in the foregoing and in the following, the electrode which is the center of an oxidation reaction, when the accumulator outputs current, i.e. when it is in a discharge process. The anode may also be described as a negative electrode.

By active material, is conventionally meant in the foregoing and in the following, the material which is directly involved in the reduction reaction occurring at the cathode.

For the cathode, it conventionally comprises a porous matrix, for example, a porous matrix in a carbonaceous material, which gives the possibility of receiving the active material of the electrode and which may also give the possibility of recovering the reaction products of the battery.

More specifically, the porous matrix may be in a carbonaceous material selected from among carbon blacks, acetylene blacks, graphite, carbon fibers and mixtures thereof. A polymeric binder (for example polytetrafluoroethylene) may give the possibility of ensuring the strength of the cathode.

The porous matrix may be associated with a current-collecting substrate, this substrate may be in a metal material (consisting of a single metal element or of an alloy of a metal element with another element), appearing for example as a plate, a sheet or a grid, a specific example of a current-collecting substrate may be a grid in nickel.

The anode as for it is calcium anode (i.e. an anode exclusively consisting of calcium). The calcium has the advantage of having a high melting point (of the order of 842° C.). Further, the calcium has a volume capacity of 2.06 Ah/cm³ equal to that of lithium. This gives the possibility with an equal volume, of introducing the same calcium capacity in a battery.

As mentioned above, the electrolyte comprises a sulfur-containing and/or phosphorus-containing oxidizing solvent and at least one strontium salt comprised in the electrolyte at a concentration ranging from 1.15 mol·L⁻¹ to 3 mol·L⁻¹, this sulfur-containing and/or phosphorus-containing oxidizing solvent also making up the active material of the cathode.

More specifically, the oxidizing solvent may be:
a sulfur-containing solvent, comprising one or several chlorine atoms, such as a solvent selected from among thionyl chloride (SOCl₂), sulfuryl chloride (SO₂Cl₂), disulfur dichloride (S₂Cl₂), sulfur dichloride (SCl₂);
a non-chlorinated sulfur-containing solvent such as sulfur dioxide (SO₂); or
a phosphorus-containing solvent and optionally sulfur-containing solvent comprising one or several chlorine atoms, such as phosphoryl trichloride (POCl₃), thiophosphoryl trichloride (PSCl₃).

Preferably, the oxidizing solvent is thionyl chloride (SOCl₂).

As regards the strontium salt, this may be a salt comprising a strontium cation Sr²⁺ associated with a halogenated anion (such as of fluorine, bromine, chlorine, iodine) based on an element selected from among aluminium, gallium, boron, indium, vanadium, silicon, niobium, tantalum, tungsten, bismuth.

Advantageously, the halogenated anion is an anion based on chlorine.

More specifically, and advantageously, this may be a salt of strontium tetrachloroaluminate Sr(AlCl₄)₂.

The salt present in the electrolyte may result from the reaction of Lewis acid and of a Lewis base, this reaction may occur ex situ, i.e. before introducing into the battery or in situ, i.e. within the battery, when the corresponding Lewis acid and Lewis base are introduced into the battery.

More specifically, the strontium salt may be made by reaction:
of a Lewis base SrX₂, wherein X represents a halogen atom, such as a chlorine atom, a bromine atom, a fluorine atom, an iodine atom; and
of a Lewis acid selected from among an aluminium halide AlX₃, a gallium halide GaX₃, a boron halide BX₃, an indium halide InX₃, a vanadium halide VX₃, a silicon halide SiX₄, a niobium halide NbX₅, a tantalum halide TaX₅, a tungsten halide WX₅, a bismuth halide BiX₃, borohydrides, chloroborates and mixtures thereof, X representing, as above, a halogen atom such as a bromine atom, a chlorine atom, a fluorine atom and an iodine atom.

Preferably, the Lewis acid is (AlCl₃) or (GaCl₃).

When the strontium salt is strontium tetrachloroaluminate Sr(AlCl₄)₂, the latter may be prepared by reaction of strontium chloride SrCl₂ with aluminium chloride AlCl₃.

The strontium salt is present in the electrolyte, at a concentration ranging from 1.15 mol·L⁻¹ to 3 mol·L⁻¹.

More specifically, the strontium salt may be present at a concentration ranging from 1.325 mol·L⁻¹ to 2 mol·L⁻¹.

Finally, still in a more specific way, the strontium salt may be present at a concentration of 1.15 mol·L⁻¹, 1.32 mol·L⁻¹, 1.5 mol·L⁻¹, 2 mol·L⁻¹ or 3 mol·L⁻¹, such as 1.5±0.1 mol·L⁻¹.

In addition to the presence of a solvent or a salt as defined above, the electrolyte may comprise one or several additives for example selected for limiting the self-discharge of the batteries and the discharge corrosion.

This and these additives may be selected from among hydrofluoric acid (HF), SO₂, salts such as GaCl₃, BiCl₃, BCl₃, GaCl₃, InCl₃, VCl₃, SiCl₄, NbCl₅, TaCl₅, PCl₅ and WCl₆.

This and these additives may be present in a content ranging from 0 to 50% of the concentration of the strontium salt.

The battery of the invention may be developed according to different technologies and in particular, according to two technologies of cylindrical batteries, which are batteries with a so-called concentric electrode structure and batteries with a so-called spiral electrode structure, these batteries may be of different formats (such as the formats AAA, AA, C, D or DD).

For batteries of so-called concentric electrode structure, they conventionally include as illustrated in FIG. 2 enclosed as an annex:
the positive electrode 11 placed at the center appearing as a carbonaceous matrix and a supporting grid, the matrix being intended to receive the catholyte 12, i.e. the solvent, the electrolytic salt(s) and optionally the additives, the solvent also ensuring the role of an active material of the positive electrode and the matrix being also intended for recovering the reaction products;
the negative electrode 13 positioned in a concentric way relatively to the positive electrode;
between the positive electrode and the negative electrode, an annular separator 15 and a disc-shaped separator 17;
a receptacle of the assembly as a cup 19, which also forms the negative pole of the battery;
a glass-metal passage 21 welded to the cup;
a pin 23 positioned in the upper portion of the battery at the glass-metal passage, this pin being the positive pole of the battery, this pin being connected to the positive electrode via a positive connection 25.

For batteries of the AA format, the anode generally has a thickness comprised between 0.3 and 1.5 mm and more specifically between 0.5 and 1 mm and the cathode generally has a thickness comprised between 0.3 and 2 mm and more specifically between 0.5 and 1.5 mm. Nickel connections are generally used for ensuring the current collection. These connections are welded to the cup for the negative electrode and to the pin of the glass-metal passage for the positive pole.

The separators have to be neutral, insulating and chemically stable in the electrolyte used. They may be in glass fibers with thicknesses ranging from 0.1 to 500 μm and, more specifically, between 0.1 and 300 μm.

According to the circuits, the positive electrode and the negative electrode may be reversed relatively to the configuration discussed above.

These batteries are generally used for applications of the <<energy>> type wherein the currents are quite small. The surface of the electrodes and mainly that of the anode is less which limits the discharge corrosion.

For batteries with a so-called spiral electrode structure, they conventionally include two planar rectangular electrodes for which the width has to be compatible with the height of the cup and having a length configured so that, once they are wound up on themselves, they form a cylinder for which the diameter allows its introduction into the cup intended to receive these electrodes.

Such a battery is illustrated in FIG. 3 enclosed in annex and includes the following elements:
the positive electrode 27 appearing as a carbonaceous matrix and a supporting grip, the matrix being intended to receive the catholyte 28, i.e. the solvent, the electrolytic salt(s) and optionally the additives, the solvent also ensuring the role of an active material of the positive electrode and the matrix being also intended for recovering the reaction products;
the negative electrode 29 wound around the positive electrode;
between the positive electrode and the negative electrode, a spiral separator 31 and a disc-shaped separator 33;
a receptacle of the assembly as a cup 35, which also forms the negative pole of the battery;
a glass-metal passage 37 welded to the cup;
a pin 39 positioned in the upper portion of the battery at the glass-metal passage, this pin forming the positive pole of the battery, this pin being connected to the positive electrode via a positive connection 41.

These batteries are rather used for applications of the <<power>> type, wherein the currents are rather high, the surface of the electrodes being larger.

Independently of the geometry of the battery, the receptacle of the assembly as a cup is preferably in steel and ensures the seal of the battery.

The exposure of a larger anode surface to thionyl chloride may make these batteries more sensitive to corrosion during storing and discharge. These batteries may for example be used in discharge profiles with pulsed current with significant periodic current in rushes.

As mentioned above, the batteries of the invention find their application in all the fields requiring the production of electric energy, in contexts where the temperature is high (notably, temperatures above 200° C.), which is notably the case, in the prospection and exploitation of oil or further in drillings intended for using geothermy. In these fields, the batteries of the invention may thus be used for electrically powering measurement systems, which already include electronic components allowing an operation at such temperatures.

The invention will now be described with reference to particular embodiments defined below and with reference to the appended figures.

### SHORT DESCRIPTION OF THE FIGURES

FIG. 1 is a diagram illustrating the operating principle of a battery Li/SOCl₂.

FIG. 2 is a sectional view of a battery with so-called concentric electrode structure according to the invention.

FIG. 3 is a sectional view of a battery with a so-called spiral electrode structure according to the invention.

FIG. 4 is a discharge curve, i.e. a curve illustrating the time-dependent change in the battery voltage U (in mV) versus time t (in hours) at constant current (17 mA) and at 210° C. with three batteries comprising an electrolyte according to the invention (curves c, d and e), and with two batteries comprising an electrolyte not compliant with the invention comprising a salt Sr(AlCl₄)₂ at 0.8 M and at 1 M (curves a and b).

FIG. 5 is a discharge curve, i.e. a curve illustrating the time-dependent change in the battery voltage U (in mV) versus time t (in hours) at constant current (17 mA) and at 210° C. with two batteries comprising an electrolyte according to the invention (curves a and b).

FIG. 6 is a discharge curve with a pulsed current at 210° C. with the following periodic current pulses: 9 s/5 mA-1 s/60 mA obtained with a battery according to the invention as defined in example 1.

FIG. 7 is a discharge curve at constant current (4 mA) and at 250° C. with two batteries comprising an electrolyte according to the invention (curves a and b).

FIG. 8 is a discharge curve at constant current (4 mA) at 20° C. with a battery according to the invention, as defined in example 1.

FIG. 9 is a discharge curve with a constant current (17 mA) at 20° C. with a battery according to the invention as defined in example 1.

FIG. 10 is a discharge curve illustrating the time-dependent change in the battery voltage U (in mV) versus time (in hours) at constant current (17 mA) and at 250° C. with a battery comprising an electrolyte according to the invention as defined in example 2.

FIG. 11 is a pulsed discharge curve at 210° C. with the following periodic current pulses: 9 s/5 mA-1 s/60 mA with the battery according to the invention as defined in example 2.

### DETAILED DISCUSSION OF PARTICULAR EMBODIMENTS

### Example 1

The object of this example is to demonstrate the performances of the batteries according to the invention in a wide range of temperatures, and notably at high temperatures, and in particular at temperatures above 200° C. (and more specifically at 210° C. and 250° C. in this example).

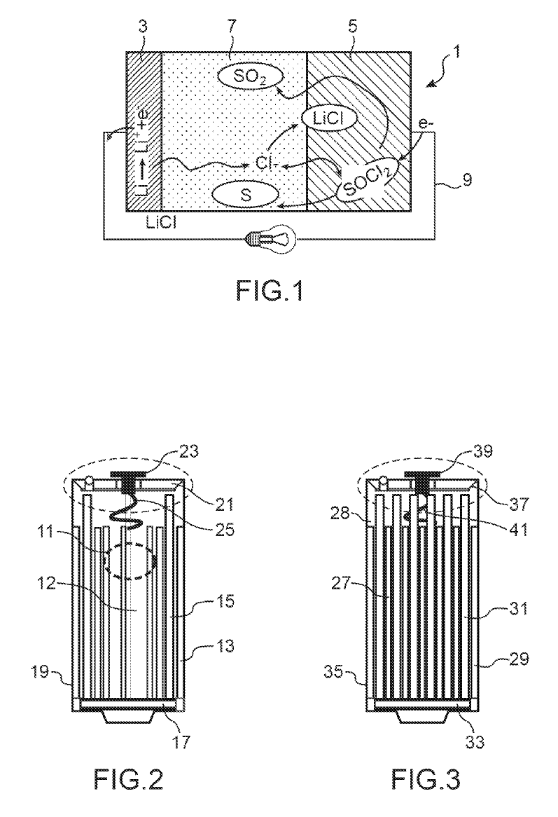

The tested batteries are of a so-called concentric electrode structure, as illustrated in FIG. 2 enclosed as an annex.

In a first test, discharge curves are determined, i.e. curves illustrating the time-dependent change in the battery voltage U (in mV) versus time (in hours) at constant current (17 mA) and at 210° C. with three batteries comprising an electrolyte according to the invention, i.e.:
a battery comprising an electrolyte comprising 1.15 M of Sr(AlCl₄)₂ in thionyl chloride (curve c);
a battery comprising an electrolyte comprising 1.32 M of Sr(AlCl₄)₂ in thionyl chloride (curve d);
a battery comprising an electrolyte comprising 1.5 M of Sr(AlCl₄)₂ (obtained by mixture of 1.5 M of SrCl₂ and of 3M of AlCl₃) in thionyl chloride (curve e);

and with two batteries comprising an electrolyte non-compliant with the invention, i.e.:
a battery comprising an electrolyte comprising a salt Sr(AlCl₄)₂ at 0.8 M in thionyl chloride (curve a);
a battery comprising an electrolyte comprising 1 M of Sr(AlCl₄)₂ in thionyl chloride (curve b).

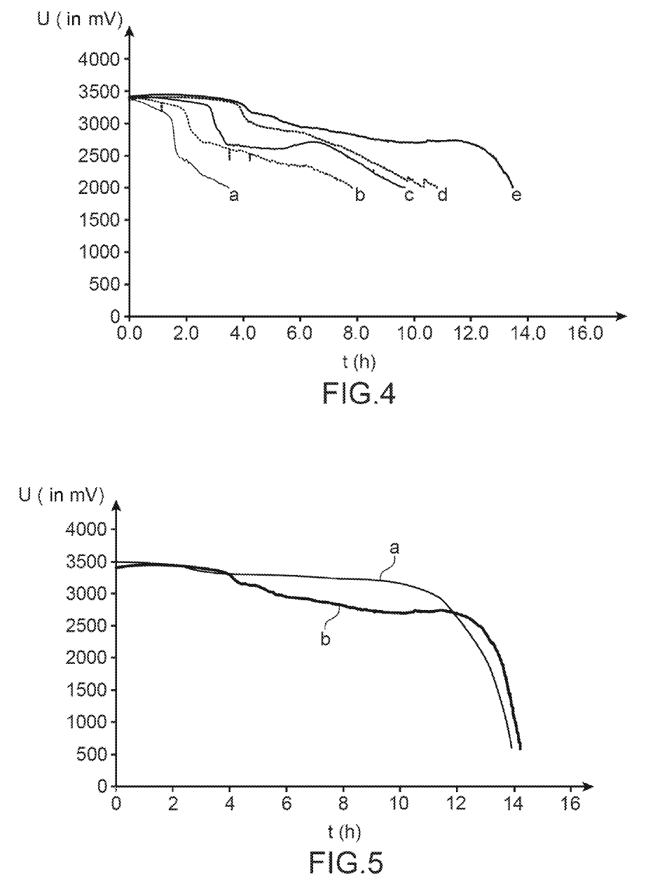

These discharge curves are illustrated in FIG. 4 enclosed as an annex.

For the batteries according to the invention, it is observed that the discharge voltage remains greater than 3 V for more than 3 hours and greater than 2.5 V for more than 7 hours from a concentration of 1.15 M and remains greater than 3V for more than 5 hours and greater than 2.5 V for more than 10 hours for a concentration of 1.5 M, while, for batteries non-compliant with the invention, there is a very significant decrease in the voltage as soon as the first hours and, notably a voltage already less than 2 V after 4 hours of use for a concentration of 0.8 M and less than 3 V after 2 hours of use for a concentration of 1 M.

This confirms the efficiency of the batteries according to the invention at high temperatures, as soon as the salt concentration is of at least 1.15 M.

Additionally, the determination of the discharge curve was carried out under the same conditions as those mentioned above, for a battery according to the invention comprising an electrolyte comprising a salt Sr(AlCl₄)₂ at 2 M in thionyl chloride which is compared with a discharge curve with another battery according to the invention comprising an electrolyte comprising a salt Sr(AlCl₄)₂ at 1.5 M in thionyl chloride.

These curves are transferred onto FIG. 5 (respectively curve a) for the battery at 2M and curve b) for the battery at 1.5 M.

For the battery at 2M, a voltage greater than 3 V is observed for 11 hours.

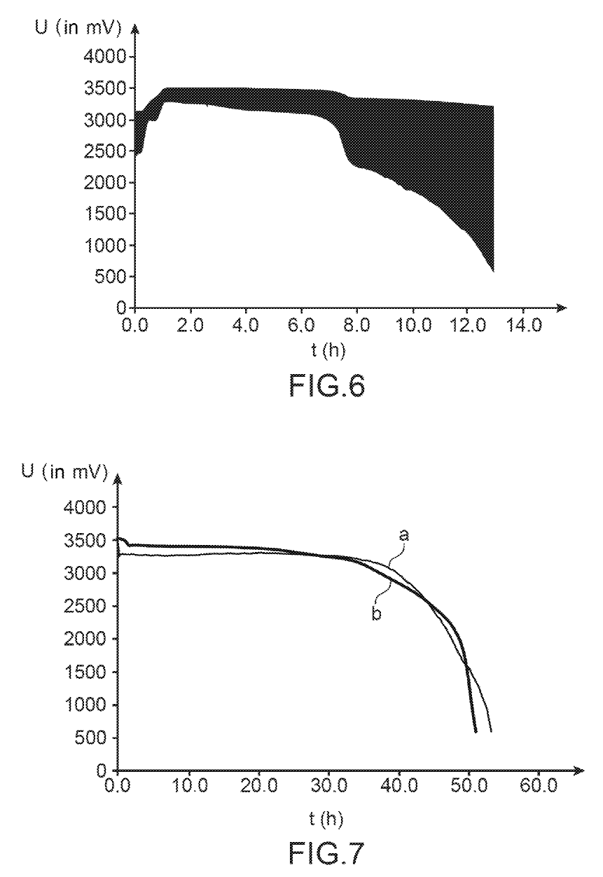

In a second test, the discharge curve is determined under a pulsed current at 210° C. with the following periodic current pulses: 9 s/5 mA-1 s/60 mA with the aforementioned battery according to the invention (battery at 1.5 M), this curve being illustrated in FIG. 6. The pulse voltage remains greater than 2 V for 9 hours, which validates the use of this type of battery for a pulsed application. It should be noted that the voltages with a current of 5 mA are high and greater than 3 V.

In a third test, the discharge curves at constant current (4 mA) and at 250° C. are determined with two batteries comprising an electrolyte according to the invention (1.5 M as defined above and a battery comprising an electrolyte comprising a salt Sr(AlCl₄)₂ at 3 M in thionyl chloride), these curves being illustrated in FIG. 7 (curve a for the battery at 3M and curve b for the battery at 1.5 M).

For both of these batteries, it may be observed that the discharge voltage remains greater than 2 V for more than 48 hours, which is very interesting at such a temperature.

The composition of the electrolyte gives the possibility of maintaining a high voltage and obtaining a discharge profile at 250° C., characteristic of the technology of primary batteries with a liquid cathode.

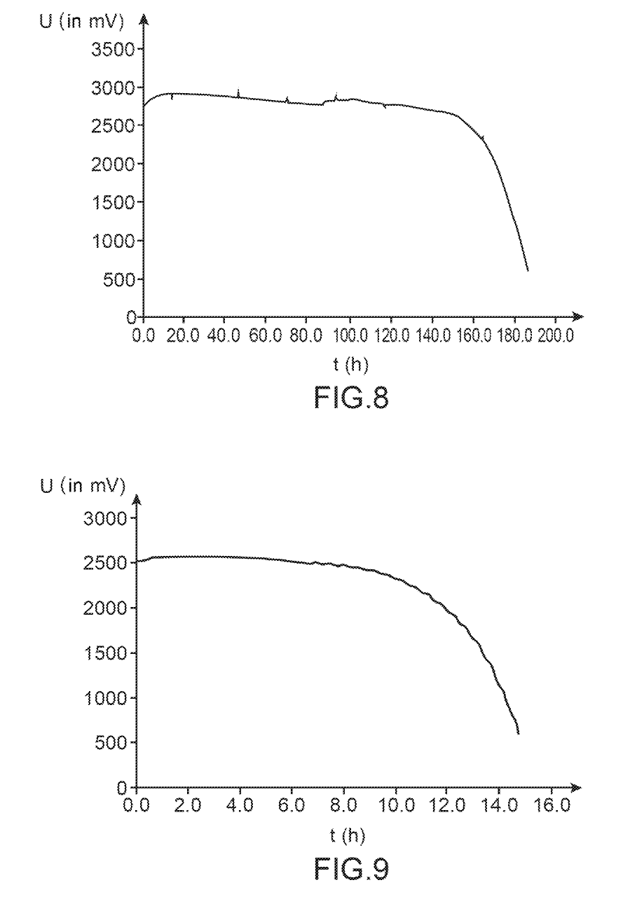

In a fourth test and in a fifth test, were determined respectively:
the discharge curve at constant current (4 mA) at 20° C. with a battery according to the invention (the battery with a salt concentration of 1.5 M), this curve being illustrated with FIG. 8;
the discharge curve at constant current (17 mA) at 20° C. with a battery according to the invention (the battery with a salt concentration of 1.5 M), this curve being illustrated with FIG. 9.

At a low current, the voltage remains greater than 2 V for more than 160 hours and with a high current, the voltage remains greater than 2 V for more than 12 hours.

This confirms the possibility of using the batteries of the invention both at room temperature and at a high temperature, as demonstrated with the preceding tests.

### Example 2

The object of this example is to demonstrate the performances of the batteries according to the invention at high temperatures, and in particular at temperatures above 200° C. (and more specifically at 210° C. and 250° C. in this example).

The tested batteries are of a so-called spiral electrode structure, as illustrated in FIG. 3 enclosed as an annex.

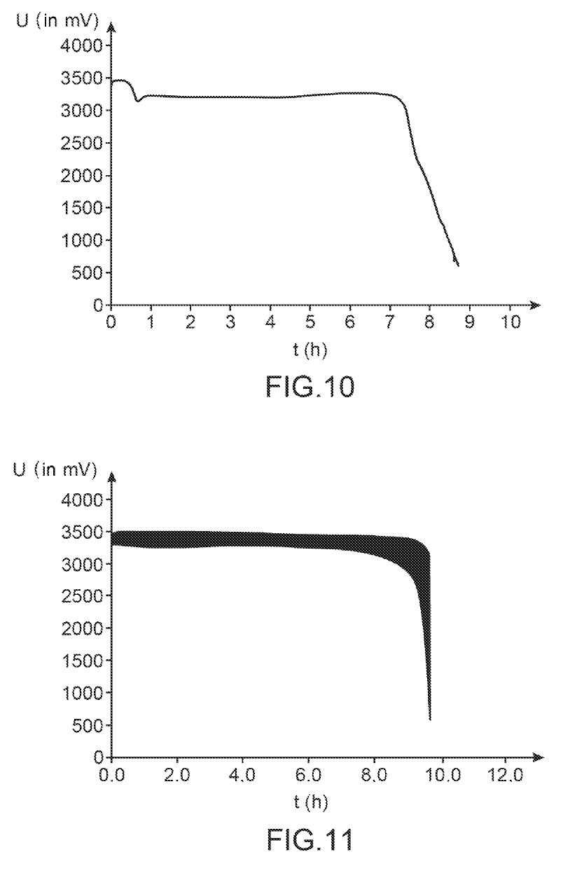

In a first test, the discharge curve is determined, i.e. the curve illustrating the time-dependent change in the battery voltage U (in mV) versus time (in hours) at constant current (17 mA) and at 250° C. with a battery comprising an electrolyte according to the invention, i.e. 1.5 M of SrCl₂ and 3M of AlCl₃ (i.e. 1.5 M of Sr(AlCl₄)₂) in thionyl chloride SOCl₂, this curve being illustrated in FIG. 10.

It is observed that the discharge voltage remains greater than 2 V for more than 10 hours.

In a second test, the discharge curve under a pulsed current at 210° C. with the following periodic current pulses: 9 s/5 mA-1 s/60 mA is determined with the aforementioned battery according to the invention, this curve being illustrated in FIG. 11.

The pulse voltage is higher during the use of concentric batteries, which validates the use of this type of battery for a pulsed application. As the surfaces of the electrodes are larger, the voltages are higher (lower current densities). The batteries with spiral electrodes are therefore more adapted to applications having a need for power (i.e. for strong currents).

1. A battery with a liquid cathode comprising:
a calcium anode;
an electrolyte comprising a sulfur-containing and/or phosphorus-containing oxidizing solvent and at least one salt;
a cathode comprising, as an active material, a compound identical with the oxidizing solvent;
wherein the salt is a strontium salt present at a concentration ranging from 1.15 mol·L⁻¹ to 3 mol·L⁻¹.

2. The battery with a liquid cathode according to claim 1, wherein the cathode comprises a porous matrix in a carbonaceous material.

3. The battery with a liquid cathode according to claim 2, wherein the carbonaceous material is selected from carbon blacks, acetylene blacks, graphite, carbon fibers or mixtures thereof.

4. The battery with a liquid cathode according to claim 2, wherein the porous matrix is associated with a current-collecting substrate, said substrate being in a metal material.

5. The battery with a liquid cathode according to claim 1, wherein the oxidizing solvent is a sulfur-containing solvent, comprising one or several chlorine atoms; a non-chlorinated sulfur-containing solvent; or a phosphorus-containing solvent and optionally sulfur-containing solvent comprising one or several chlorine atoms.

6. The battery with a liquid cathode according to claim 5, wherein the sulfur-containing solvent comprising one or several chlorine atoms is selected from thionyl chloride (SOCl₂), sulfuryl chloride (SO₂Cl₂), disulfur dichloride (S₂Cl₂), or sulfur dichloride (SCl₂).

7. The battery with a liquid cathode according to claim 5, wherein the non-chlorinated sulfur-containing solvent is sulfur dioxide.

8. The battery with a liquid cathode according to claim 5, wherein the phosphorus-containing and optionally sulfur-containing solvent comprising one or several chlorine atoms is selected from phosphoryl trichloride (POCl₃), or thiophosphoryl trichloride (PSCl₃).

9. The battery with a liquid cathode according to claim 1, wherein the oxidizing solvent is thionyl chloride (SOCl₂).

10. The battery with a liquid cathode according to claim 1, wherein the strontium salt is a salt comprising a strontium cation Sr²⁺ associated with a halogenated anion based on an element selected from aluminium, gallium, boron, indium, vanadium, silicon, niobium, tantalum, tungsten, or bismuth.

11. The battery with a liquid cathode according to claim 10, wherein the halogenated anion is based on chlorine.

12. The battery with a liquid cathode according to claim 1, wherein the strontium salt is the strontium tetrachloroaluminate salt Sr(AlCl₄)₂.

13. The battery with a liquid cathode according to claim 1, wherein the strontium salt results from the reaction in situ of a Lewis acid and of a Lewis base.

14. The battery with a liquid cathode according to claim 1, wherein the electrolyte comprises one or several additives selected from hydrofluoric acid (HF), SO₂, GaCl₃, BiCl₃, BCl₃, GaCl₃, InCl₃, VCl₃, SiCl₄, NbCl₅, TaCl₅, PCl₅ or WCl₆.

15. The battery with a liquid cathode according to claim 1, which is a concentric electrode structure battery or a battery with a spiral electrode structure.

16. The battery with a liquid cathode according to claim 3, wherein the porous matrix is associated with a current-collecting substrate, said substrate being in a metal material.
